(19) United States
(12) Patent Application Publication
(10) Pub. No.: US 2005/0202134 A1
(43) Pub. Date: Sep. 15, 2005

(54) Process for the manufacture of cheese base and the products made therefrom

(75) Inventor: Craig J. Schroeder, Lino Lakes, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Land O'Lakes, Inc., Arden Hills, MN (US)

(21) Appl. No.: 10/799,252

(22) Filed: Mar. 12, 2004

(51) Int. Cl. C12H 1/04

(52) U.S. Cl. 426/271

(57) ABSTRACT

Milk or a milk derivative is treated with a chelating agent in a manner that provides sufficient turbulence during mixing to avoid localized protein precipitation. The chelating agent is added to the milk or the milk derivative between a pH of about 5.8 and 6.6. The milk or the milk derivative is then subjected to ultrafiltration wherein calcium freed from the milk or the milk derivative is passed as a permeate and a retentate is retained as the cheese base.

### BACKGROUND OF THE INVENTION

The present invention generally relates to a method of manufacturing a cheese base directly from milk for use as a feedstock in the production of a cheese-base which is used as an ingredient in process cheese-type products. More particularly, the present invention relates to a method of adding a chelating acid to milk that binds free calcium where the bound calcium is removed from the milk by ultrafiltration. The present invention also includes products made by the method of the present invention.

A cheese base is a starting component for cheese-based products. As used herein, cheese-based products include process cheese, cheese food, cheese sauce, cheese spreads and imitation or analog cheese where the cheese base can compose up to about 80 percent of the cheese-based product. Most cheese bases are made using batch processes that are time consuming and are not as efficient as a continuous process.

Milk is a starting component for both cheese and cheese base.

Attempts have been made to create a commercially successful continuous process to make a cheese base directly from milk and bypassing time consuming curd formation and the subsequent processing of the curd.

An obstacle in producing a cheese base directly from milk is that milk is composed of about 90 weight percent water. To process milk directly into a cheese base without forming a curd, where the water is drained from the curd as whey, the moisture content of the milk must be reduced to approximately the moisture content of the cheese-based product.

A publication by Ernstrom indicates that a cheese base made directly from milk by ultrafiltration was excessively hard and contained large amounts of gritty calcium lactate on the surface of the cheese base. The Ernstrom publication also indicated that milk acidified with hydrochloric acid to a pH of 5.7 produced a cheese base with texture similar to that of natural cheese because the reduction in pH of the milk freed calcium which was removed with the permeate during ultrafiltration. However, the free calcium fouled the ultrafiltration membranes over time.

U.S. Pat. No. 6,183,805 to Moran et al. also discloses a cheese base processed directly from milk. The Moran et al. patent discloses an acidification step with lactic acid followed by an incubation period of between four and twenty-four hours where the pH of the milk was gradually lowered through ion exchange. During the incubation period, the free calcium is gradually solubilized and bound with the lactate ion. However, a significant amount of time is required when using ion exchange to bind the free calcium.

### SUMMARY OF THE INVENTION

The present invention includes a method of making a cheese base from milk or a milk derivative. The method includes treating the milk or the milk derivative with citric acid in a manner that provides sufficient turbulence during mixing that avoids localized protein precipitation. The citric acid is added in an amount sufficient to chelate calcium and lower the pH of the milk or the milk derivative to between about 5.8 and 6.6. After acidification, the milk or the milk derivative is subjected to ultrafiltration wherein calcium freed from the milk or the milk derivative is passed with the permeate and a retentate is retained for fermentation and further concentration into a cheese base.

### BRIEF DESCRIPTION OF THE PREFERRED EMBODIMENTS

The present invention includes a method of continuously producing a cheese base directly from milk. The milk is acidified to free calcium from the bound or colloidal form, and a chelating agent is added to chelate the free calcium. Alternatively, a single substance that can both acidify the milk and chelate the free calcium may be added. The acified, chelator-treated milk is ultrafiltered to remove at least some of the chelated calcium and at least some of the free calcium along with water and lactose from the milk. The retentate is fermented and concentrated through evaporation to the moisture content of a selected cheese.

In addition to using milk, a milk derivative can also be used in the method of the present invention. By milk derivative is meant the addition of any generally recognized as safe (GRAS) ingredients to milk including, but not limited, to skim milk, cream, butter oil, vegetable oils and fats, flavorants, functional carbohydrates such as starches, gums, and pectin, non-dairy proteins such as soy protein, anti-microbial agents such as sorbic acid, proteins, such as casein and whey proteins, demineralized whey, and sugars such as lactose.

Prior to the milk being acidified, a standardized milk may be produced by adding cream or removing cream from the milk such that the milk is standardized to a selected protein to fat ratio. The protein to fat ratio is adjusted to conform to the type of cheese product to be made from the cheese base.

The standardized milk is pasteurized at between approximately 161° F. and 170° F. for about 15-30 seconds. After pasteurization, the standardized milk is cooled to a selected temperature, preferably between about 80° F. and 100° F.

Once cooled to the selected temperature, a chelating agent and suitable acid, or preferably a chelating acid is added to the pasteurized milk. What is meant by a chelating agent is a chemical compound that bonds with a metal ion such as calcium to form a heterogeneous ring. Chelating agents have a number of metal-complexing sites, allowing one chelator molecule to interact with the four or six interaction sites of metal ions. Chelators tend to form stable five-membered ring structures with metal ions.

Chelation and acidification can take place by addition of separate agents, such as EDTA to chelate and acetic acid (or acetic anhydride) to acidify. Alternatively, a single compound having both chelating and acidification properties, such as citric acid, can be employed.

The chelating agent is added to the pasteurized milk where the flow of the milk is sufficiently turbulent to prevent localized lower pH zones which cause a protein precipitate to form. Sufficiently turbulent conditions are achieved by operating preferably under conditions providing a Reynold's number above approximately 5000, and more preferable in the approximate range 5600-6300. Alternatively, the chelating agent can be added to the milk upstream of an in-line static mixer such that the chelating agent is sufficiently mixed into the pasteurized milk with the in-line static mixer to prevent localized lower pH zones and the formation of gritty protein precipitates.

A preferred chelating agent is citric acid, although other chelating agents are within the scope of the present invention. A non-exhaustive list of chelating agents that may be used in accordance with the present invention includes, but is not limited to, food-grade chelating agents such as EDTA (Ethylenediaminotetraacetate), such as Versene 100 (Na₄EDTA), Versene Diammonium EDTA (NH₄)₄EDTA, and Versene acid (H₄EDTA) from Dow Chemical Company, Midland, Mich.; Phosphates, such as pyrophosphate (P₂O₇); free organic acids and their alkali metal salts; such as citric acid, malic acid, gluconic acid, sodium citrate, disodium citrate, potassium citrate, sodium carbonate, potassium carbonate, sodium bicarbonate, potassium bicarbonate; polyphosphates such as: sodium tripolyphosphate, sodium hexa metaphosphate, sodium acid pyrophosphate, monopotassium dihydrogen orthophosphate, dipotassium hydrogen orthophosphate, tripotassium orthophosphate, and monosodium phosphate, dipotassium phosphate, trisodium phosphate (TSP), tetrasodium pyrophosphate, sodium aluminum phosphate, and sodium potassium tartrate, and mixtures thereof. Sodium citrate and potassium citrate are sold by Cargill Inc. of Eddyville, Ill. USA, sodium gluconate, sodium tartrate, are available from Brenntag Northeast, Inc. Reading, Pa. and sodium hexa meta phosphate is sold by FMC Phosphorus Chem. Of Philadelphia, Pa. USA.

A preferred acidification agent is citric acid, although other acidification agents are within the scope of the present invention. A non-exhaustive list of acidification agents that may be used in accordance with the present invention includes, but is not limited to tannic acid, malic acid, and gluconic acid from Brenntag Northeast, Inc. Reading, Pa.; citric acid, glycolic acid, pyruvic acid, glutamic acid, fumaric acid, succinic acid, isocitric acid, and pimelic acid; linear polycarboxylic acids, such as oxalic acid, malonic acid, succinic acid, gluratic acid, acetic acid, propionic acid, butyric acid, and adipic acid; and anhydrides that break down into acids on contact with water, such as acetic anhydride, butyric anhydride, succinic anhydride or any combination thereof.

Preferably, citric acid is added to the milk in a solution containing approximately 10-weight percent citric acid, although other weight percent solutions of citric acid are within the scope of the invention. The citric acid is added at a rate sufficient to drop the pH to between about 5.8-6.6 and preferably about 6.2 With the pH of the pasteurized milk reduced to within the range of 5.8-6.6, some of the calcium within the milk is solubilized or freed. Preferably, at least approximately 5% of the calcium within the milk is solubilized or freed. More preferably, between about 5% and about 25% of the calcium within the milk is solubilized or freed. Once solubilized, the calcium reacts with citric acid to form a chelate complex. The reaction between the solubilized or freed calcium and the citric acid occurs almost instantaneously such that the acidified pasteurized milk stream can be transferred directly into an ultrafiltration unit and processed substantially immediately thereafter.

Within the ultrafiltration unit, the acidified milk is concentrated to between about a fourth and a fifth of the initial volume of the acidified milk entering the ultrafiltration unit. As the milk is condensed, the chelating complexes, including the bound solubilized calcium, pass through the membranes of the ultrafiltration unit and exit the milk as permeate without membrane fouling or formation of a gritty precipitate. An exemplary ultrafiltration unit is manufactured by Abcor of Wilmington, Mass. The ultrafiltration unit is preferably operated at about 8-30 psig and at about 125° F.

The retentate constitutes an intermediate that may be used as the cheese base of the present invention. Alternatively, the retentate may be further processed. Further processing of the intermediate may include the addition of GRAS ingredients such as emulsifying salts, flavorants, functional carbohydrates such as starches, gums, and pectin, non-dairy proteins such as soy protein and anti-microbial agents such as sorbic acid, the addition of a fermenting agent and further reduction of the moisture content of the retentate.

Further, a culture may be optionally added to the retentate to ferment the retentate and create a cheese spread or a cheese base for a specific cheese-based product. A non-exhaustive list of cultures that may be added to the retentate include but are not limited to Lactococcus lactis, subsp. lactis, Lactococcus lactis, subsp. diacetylactis, Streptococcus thermophilus, and/or Lactobacillus species. The culture ferments the intermediate to form a fermentate.

Rennet may also be optionally added to the fermentate. Rennet is optionally added to the fermentate to adjust the body and flavor of the cheese base depending upon the formula and the variety of the cheese-based product into which the cheese base is added.

After the optional addition of the culture and rennet, additional moisture may optionally be removed from the intermediate or the fermentate so that the moisture content of the cheese base corresponds to the cheese base product of which the cheese base is an ingredient. The moisture content of the intermediate is preferably reduced by processing the intermediate through thin film evaporation. An example of a thin film evaporator is Turba-Film evaporator manufactured by Cherry-Burrell of AMCA International, Louisville, Ky.

The process of the present invention is a commercially viable process because the membranes of the ultrafiltration unit do not foul from calcium that is solubilized by the pH reduction. Rather, the calcium is bound as a chelate complex and passes through the membrane

The cheese base made by the process of the present invention, because of the reduction in calcium, is softer and more easily packaged than a cheese base that includes an unreduced amount of calcium. Additionally, the cheese base of the present invention is more easily processed into cheese-based products because of the texture and packaging capabilities. Further the cheese base made by the process of the present invention, because of the softness and ease in packaging, is adaptable in making a variety of the cheese based products

The cheese base of the present invention is characterized by a soft texture and lower calcium content than other products made by a similar process without the use of chelating acid prior to ultrafiltration. Cheese base made using this process would contain approximately 5-25% less total calcium as a result of acid addition. Calcium would be removed via the permeate during the ultrafiltration and diafiltration steps.

Although the present invention has been described with reference to preferred embodiments, workers skilled in the art will recognize that changes may be made in form and detail without departing form the spirit and scope of the invention.

1. A method of making a cheese base, the method comprising:
mixing milk or a milk derivative with a chelating agent in a manner that provides sufficient turbulence at the locus of mixing such that localized protein precipitation is avoided and adding the chelating agent in an amount sufficient to chelate calcium; and
subjecting the milk or the milk derivative to ultrafiltration thereby passing calcium freed from the milk or milk derivative with a permeate and obtaining a retentate cheese base.

2. The method of claim 1 wherein the chelating agent lowers the pH of the milk or the milk derivative to be between about 5.8 and 6.6.

3. The method of claim 2 and wherein the chelating agent is added to the milk or the milk derivative to adjust the pH of the milk to about 6.2.

4. The method of claim 1 wherein the chelating agent is citric acid.

5. The method of claim 1 and introducing substantially with the chelating agent into the turbulent flowing milk or milk derivative stream an acidification agent in an amount sufficient to lower the pH of the milk or milk derivative stream to a pH between about 5.8 and 6.6.

6. The method of claim 5 wherein the chelating agent and the acidification agent are introduced substantially simultaneously into the milk or milk derivative stream.

7. The method of claim 5 wherein the acidification agent comprises tannic acid, malic acid, gluconic acid, citric acid, glycolic acid, pyruvic acid, glutamic acid, fumaric acid, succinic acid, isocitric acid, pimelic acid, oxalic acid, malonic acid, gluratic acid, adipic acid, acetic acid, propionic acid, butyric acid, acetic anhydride, butyric anhydride or succinic anhydride or any combination thereof.

8. The method of claim 1 wherein the chelating agent comprises ethylenediaminotetraacetate, pyrophosphate, citric acid, malic acid, gluconic acid, sodium citrate, disodium citrate, potassium citrate, sodium carbonate, potassium carbonate, sodium bicarbonate, potassium bicarbonate, sodium tripolyphosphate, sodium hexa metaphosphate, sodium acid pyrophosphate, monopotassium dihydrogen orthophosphate, dipotassium hydrogen orthophosphate, tripotassium orthophosphate, monosodium phosphate, dipotassium phosphate, trisodium phosphate, tetrasodium pyrophosphate, sodium aluminum phosphate, sodium potassium tartrate, or mixtures thereof.

9. The method of claim 1 and wherein the chelating agent is added under conditions providing a Reynolds number of at least about 5000.

10. The method of claim 4 and wherein the citric acid is added to the milk or the milk derivative in about a 10 weight percent solution.

11. The method of claim 1 and further comprising adding an emulsifying salt to the retentate cheese base.

12. The method of claim 1 and further comprising adding a culture to the retentate cheese base wherein the culture ferments the retentate cheese base to form a fermentate.

13. The method of claim 9 and further comprising adding rennet to the fermentate.

14. The method of claim 1 and further comprising evaporating water from the retentate cheese base such that the cheese base has a moisture content approximately equal to a moisture content of a cheese-based product of which the retentate cheese base is an ingredient.

15. The cheese base produced by the method of claim 1 characterized by a softer texture than a cheese base having no calcium extracted from a milk ingredient.

16. The cheese base produced by the method of claim 1 characterized by a reduction in calcium of at least 5% relative to a cheese base having no calcium extracted from a milk ingredient.

17. The cheese base of claim 9 and wherein the cheese base comprises an ingredient of a process cheese, a cheese food, a cheese spread, a cheese sauce or an imitation or analog cheese.

18. The cheese base of claim 14 and wherein the cheese base comprises an ingredient of a process cheese, a cheese food, a cheese spread, a cheese sauce or an imitation or analog cheese.

19. A method of continuously making a cheese base, the method comprising:
providing a stream of milk or a milk derivative having turbulent flow characteristics;
introducing a chelating agent into the turbulent flowing milk or milk derivative stream in a manner such that the chelating agent does not produce localized conditions that causes proteins in the milk or the milk derivative stream to precipitate and chelates calcium such that calcium is freed from the milk or the milk derivative and is bound by the chelating agent; and
subjecting the milk to ultrafiltration to remove the free calcium from the milk as permeate along with water such that retentate has a reduced calcium concentration.

20. The method of claim 19 and introducing with the chelating agent into the turbulent flowing milk or milk derivative stream an acidification agent in an amount sufficient to lower the pH of the milk or milk derivative stream to a pH between about 5.8 and 6.6.

21. The method of claim 20 wherein the chelating agent and the acidification agent are introduced substantially into the milk or milk derivative stream.

22. The method of claim 19 wherein the chelating agent lowers the pH of the milk or milk derivative stream to between about 5.8 and 6.6.

23. The method of claim 21 wherein the chelating agent is citric acid.

24. The method of claim 20 wherein the acidification agent comprises tannic acid, malic acid, gluconic acid, citric acid, glycolic acid, pyruvic acid, glutamic acid, fumaric acid, succinic acid, isocitric acid, pimelic acid, oxalic acid, malonic acid, gluratic acid, adipic acid, acetic acid, propionic acid, butyric acid, acetic anhydride, butyric anhydride or succinic anhydride or any combination thereof.

25. The method of claim 19 wherein the chelating agent comprises ethylenediaminotetraacetate, pyrophosphate, citric acid, malic acid, gluconic acid, sodium citrate, disodium citrate, potassium citrate, sodium carbonate, potassium carbonate, sodium bicarbonate, potassium bicarbonate, sodium tripolyphosphate, sodium hexa metaphosphate, sodium acid pyrophosphate, trisodium phosphate, monopotassium dihydrogen orthophosphate, dipotassium hydrogen orthophosphate, tripotassium orthophosphate, monosodium phosphate, dipotassium phosphate, tetrasodium pyrophosphate, sodium aluminum phosphate, sodium potassium tartrate, or mixtures thereof.

26. The method of claim 19 and wherein the chelating agent is added under conditions providing a Reynolds number of at least about 5000.

27. The method of claim 19 and wherein the calcium content of the retentate is reduced at least 5% relative to a cheese base having no calcium extracted from a milk ingredient.

28. The method of claim 19 and wherein the chelating agent comprises citric acid.

29. The method of claim 28 and wherein the citric acid comprises about a ten weight percent solution of citric acid.

30. The method of claim 19 and further comprising adding an emulsifying salt to the retentate cheese base.

31. The method of claim 29 and further comprising adding a culture to the retentate wherein the culture ferments the retentate to form a fermentate.

32. The method of claim 31 and further comprising adding rennet to the fermentate.

33. The method of claim 19 and further comprising evaporating water from the retentate cheese base such that the cheese base has a moisture content approximately equal to a moisture content of a cheese-based product of which the retentate cheese base is an ingredient.

34. The method of claim 31 and further comprising evaporating water from the retentate such that the retentate has a moisture content approximately equal to a moisture content of a product of which the retentate is an ingredient.

35. The cheese base produced by the method of claim 19 characterized by a softer texture than a cheese base having no calcium extracted from a milk ingredient.

36. The cheese base produced by the method of claim 19 characterized by a reduction in calcium of at least 5% relative to a cheese base having no calcium extracted from a milk ingredient.

37. The cheese base produced by the method of claim 34 characterized by a reduction in calcium of at least 5% relative to a cheese base having no calcium extracted from a milk ingredient.

38. The cheese base of claim 35 and wherein the cheese base comprises an ingredient of a process cheese, a cheese food, a cheese sauce, a cheese spread, or an imitation or analog cheese.

39. The cheese base of claim 36 and wherein the cheese base comprises an ingredient of a process cheese, a cheese food, a cheese sauce, a cheese spread, or an imitation or analog cheese.

40. The cheese base of claim 34 and wherein the cheese base comprises an ingredient of a process cheese, a cheese food, a cheese sauce, a cheese spread, or an imitation or analog cheese.

41. A method of preventing membrane fouling during the removal of calcium from milk or a milk derivative during ultrafiltration, the method comprising:
providing a stream of milk or a milk derivative having turbulent flow characteristics;
introducing a chelating agent into the turbulent flowing milk or milk derivative stream in a manner such that the chelating agent does not produce localized reduced pH locations that cause proteins in the milk or milk derivative stream to precipitate and wherein calcium is freed from the milk or milk derivative and bound by the chelating agent; and
subjecting the milk or milk derivative to ultrafiltration to remove the calcium from the milk as permeate along with water such that the calcium does not foul the membrane.

42. The method of claim 41 and introducing substantially simultaneously with the chelating agent into the turbulent flowing milk or milk derivative stream an acidification agent in an amount sufficient to lower the pH of the milk or milk derivative stream to a pH between about 5.8 and 6.6.

43. The method of claim 41 wherein the chelating agent lowers the pH of the milk or milk derivative stream to between about 5.8 and 6.6.

44. The method of claim 43 and wherein the chelating acid comprises citric acid.

45. The method of claim 44 and wherein the citric acid comprises no more than a ten weight percent solution of citric acid.

46. The method of claim 42 wherein the acidification agent comprises tannic acid, malic acid, gluconic acid, citric acid, glycolic acid, pyruvic acid, glutamic acid, fumaric acid, succinic acid, isocitric acid, pimelic acid, oxalic acid, malonic acid, gluratic acid, adipic acid, acetic acid, propionic acid, butyric acid, acetic anhydride, butyric anhydride or succinic anhydride or any combination thereof.

47. The method of claim 41 wherein the chelating agent comprises ethylenediaminotetraacetate, pyrophosphate, citric acid, malic acid, gluconic acid, sodium citrate, disodium citrate, potassium citrate, sodium carbonate, potassium carbonate, sodium bicarbonate, potassium bicarbonate, sodium tripolyphosphate, sodium hexa metaphosphate, sodium acid pyrophosphate, trisodium phosphate, monopotassium dihydrogen orthophosphate, dipotassium hydrogen orthophosphate, tripotassium orthophosphate, monosodium phosphate, dipotassium phosphate, tetrasodium pyrophosphate, sodium aluminum phosphate, sodium potassium tartrate, or mixtures thereof.

48. The method of claim 41 and wherein the chelating agent is added under conditions providing a Reynolds number of at least about 5000.

49. A method of making a cheese base, the method comprising:
adding a chelating agent to milk or a milk derivative in a turbulent manner sufficient to avoid localized protein precipitation at a pH in an approximate range of 5.8 to 6.6; and
ultrafiltering the milk or milk derivative thereby passing freed calcium with a permeate and retaining a retentate suitable as the cheese base.

50. The method of claim 49 and introducing with the chelating agent into the turbulent flowing milk or milk derivative stream an acidification agent in an amount sufficient to lower the pH of the milk or milk derivative stream to a pH between about 5.8 and 6.6.

51. The method of claim 50 wherein the chelating agent and the acidification agent are introduced substantially simultaneously.

52. The method of claim 49 wherein the chelating agent is citric acid.

53. The method of claim 49 and wherein the chelating agent is added under conditions providing a Reynolds number of at least about 5000.

54. The method of claim 50 wherein the acidification agent comprises tannic acid, malic acid, gluconic acid, citric acid, glycolic acid, pyruvic acid, glutamic acid, fumaric acid, succinic acid, isocitric acid, pimelic acid, oxalic acid, malonic acid, gluratic acid, adipic acid, acetic acid, propionic acid, butyric acid, acetic anhydride, butyric anhydride or succinic anhydride or any combination thereof.

55. The method of claim 49 wherein the chelating agent comprises ethylenediaminotetraacetate, pyrophosphate, citric acid, malic acid, gluconic acid, sodium citrate, disodium citrate, potassium citrate, sodium carbonate, potassium carbonate, sodium bicarbonate, potassium bicarbonate, sodium tripolyphosphate, sodium hexa metaphosphate, sodium acid pyrophosphate, trisodium phosphate, monopotassium dihydrogen orthophosphate, dipotassium hydrogen orthophosphate, tripotassium orthophosphate, monosodium phosphate, dipotassium phosphate, tetrasodium pyrophosphate, sodium aluminum phosphate, sodium potassium tartrate, or mixtures thereof.

56. The method of claim 52 and wherein the citric acid is added to the milk or the milk derivative in about a 10 weight percent solution.

57. The method of claim 49 and further comprising adding an emulsifying salt to the retentate cheese base.

58. The method of claim 49 and further comprising adding a culture to the retentate wherein the culture ferments the retentate to form a fermentate.

59. The method of claim 58 and further comprising adding rennet to the fermentate.

60. The method of claim 49 and further comprising evaporating water from the retentate such that the retentate has a moisture content approximately equal to a moisture content of a product of which the retentate is an ingredient.

61. The method of claim 58 and further comprising evaporating water from the retentate such that the retentate has a moisture content approximately equal to a moisture content of a product of which the retentate is an ingredient.

62. The cheese base produced by the method of claim 44 characterized by a softer texture than a cheese base having no calcium extracted from a milk ingredient.

63. The cheese base produced by the method of claim 55 characterized by a reduction in calcium of at least 5% relative to a cheese base having no calcium extracted from a milk ingredient.

64. A cheese base produced by the method of claim 61 characterized by a reduction in calcium of at least 5% relative to a cheese base having no calcium extracted from a milk ingredient.

65. The cheese base of claim 62 and wherein the cheese base comprises an ingredient of a process cheese, a cheese food, a cheese spread, a cheese sauce or an imitation or analog cheese.
